(19) United States
(12) Patent Application Publication
(10) Pub. No.: US 2016/0318254 A1
(43) Pub. Date: Nov. 3, 2016

(54) System and Method for Creating Decorative Apparel

(71) Applicant: My Fabric Designs Corporation, Dallas, TX (US)

(72) Inventors: Roy Garland, III, Dallas, TX (US); Marvin Leon Gardner, Dallas, TX (US); Gary Allen Gardner, Dallas, TX (US)

(21) Appl. No.: 14/699,371

(22) Filed: Apr. 29, 2015

(51) Int. Cl. B29C 67/00; G06F 17/50; G05B 19/4099; G06T 15/00

(52) U.S. Cl. CPC B29C 67/0088; G06T 15/005; G06F 17/50; G05B 19/4099; G05B 2219/35533; G05B 2219/35134

(57) ABSTRACT

A method for creating and uploading a custom image or design for creating a 3D rendering of an article printed with the custom image or design is disclosed herein. An article is selected and displayed with pattern pieces for making the article on a display. The user selects and uploads an electronic file which includes a design that the user desires to place on the article and which is then positioned on one or more of pattern pieces as desired by the user. The 2D pattern pieces are then rendered into a 3D object that displays the article with the design on the article on a display. The user may then reconfigure the design on the article or proceed with printing the pattern pieces for making the article with the design thereon or transmit electronic instructions providing for the manufacture of the article with the design thereon.

### TECHNICAL FIELD

The illustrative embodiments relate generally to the design of apparel, and more particularly, to a system and method for uploading graphic images or artwork for creation and display of custom designed apparel for a user.

### BACKGROUND

Articles, such as clothing items, fabrics, upholstery, coverings, toys, boxes, furniture and other physical objects for use in a variety of applications, may be printed, embroidered, silk screened or otherwise imprinted with a logo, design or other artwork so that such article comprises a unique article. Creating and imprinting an article with a unique or custom design or image requires one to plan and dimension the design to be imprinted on the article pattern and translate that design from a two-dimensional (2D) drawing of the pattern pieces into a three-dimensional (3D) drawing of the article with design which requires a great amount of time and expertise in mathematics and dimensional analysis to properly translate the design into the appropriate 3D rendering. Other inconveniences and problems may be encountered when imprinting a 2D design on to an article that lead to inaccurate sizing, orientation of the design on the article or error in the creation of the pattern for making the article with design thereon.

### SUMMARY

According to an embodiment, a method for creating and uploading a custom image or design for creating a 3D rendering of an article printed with the custom image or design comprises the steps of: displaying an article, wherein the article comprises one or more pattern pieces that form the article; selecting and uploading one or more designs to be placed on the one or more pattern pieces; positioning the one or more designs on the one or more pattern pieces; and rendering the one or more pattern pieces into a three-dimensional object depicting the article with the one or more designs depicted on the article on a display.

According to another illustrative embodiment, a computer program product in a computer readable medium for use in creating and uploading a custom image or design, the computer program product comprises: instructions for displaying an article, wherein the article comprises one or more pattern pieces that form the article; instructions for selecting and instructions for uploading one or more designs to be placed on the one or more pattern pieces; instructions for positioning the one or more designs on the one or more pattern pieces; and instructions for rendering the one or more pattern pieces into a three-dimensional object depicting the article with the one or more designs depicted on the article on a display.

### BRIEF DESCRIPTION OF THE DRAWINGS

FIG. 1 is a generalized diagram of a network system according to an embodiment of the invention described herein;

FIG. 2 is a flow diagram illustrating the rendering of a three-dimensional object depicting the article with design according to an embodiment of the invention described herein; and,

FIG. 3 depicts a schematic block diagram of a data processing system in which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to make and practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those of skill in the art. The following written description is, therefore, not to be taken in a limiting sense, and the scope of the illustrative embodiments are defined only by the appended claims.

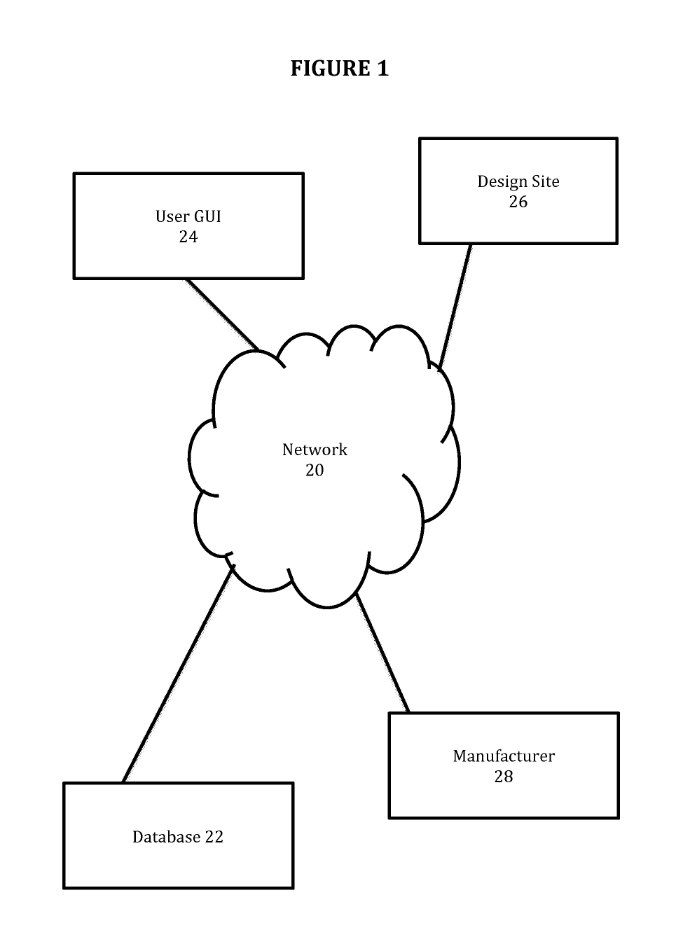

Turning to FIG. 1, a general network 20 diagram is shown that includes a digital communication system interconnecting local or wide-area network accessible devices, hosts, computers, servers or other processor and/or storage, user graphical user interface (GUI) 24, database 22, design site 26 and manufacturer 28. User GUI 24 may use commonly known graphical user interfaces (GUI) devices which are broadly construed herein to include and mean any graphical, audio, video, or other media display or sensing system for communicating digital or analog input and/or output of one or more programs or functions, such as presenting icons of objects, buttons or selections, dialog boxes or windows, toolsets, displaying two-dimensional (2D) and three-dimensional (3D) renderings of visual objects, articles, pattern pieces and other audio visual information on the screen of the GUI. The GUI receives, displays and transmits information which allows the user select and view an article with corresponding pattern pieces; select or upload one or more designs to be printed or placed on one or more pattern pieces which may be stored locally on user GUI 24, database 22 or design site 26; add, remove and/or position and re-position the one or more designs and/or design files on the one or more pattern pieces; and, view a 3D rendering of the article depicting the one or more designs printed or otherwise displayed on the article. The article may be displayed in 3D along with a body profile of a male or female person, animal, furniture piece or other object for which the article is to be utilized or worn. In another embodiment, the user may select or upload one or more designs or design files to a software application or other modality.

Design site 26 includes hardware and software components necessary to allow user GUI 24 to receive, view and transmit communications and information to accomplish the method disclosed herein. Design site 26 includes simulation and application software for rendering the 2D article pattern pieces into a 3D representation of the article with the desired design uploaded by the user. Design site 26 includes articles with corresponding article pattern pieces from which the user may choose and select. Design site 26 may include templates that employ one or more adaptive, neural, fuzzy, Bayesian, or other intelligent control or programming method or algorithm to apply or design one or more article elements or parameters according to one or more predefined or stored user rule sets, fabric categories, article, garment and pattern piece shapes and sizes. In this context, fabric categories may include fabric or material type, shape, texture, or patterns. It is to be understood that article may encompass clothing, headwear, footwear, toys, furniture, fashion accessories, or other items upon which the user wishes to place a custom design using the methods and system disclosed herein.

Manufacturer 28 comprises a manufacturing site that includes hardware and software components for receiving from and transmitting information to database 22, user GUI 24 and design site 26 that allow the user to request the manufacture of the article created by the user which incorporates the unique or custom design elements selected and positioned by the user on the corresponding article pattern pieces during the design of the article. In an embodiment, after the user has created the article with a custom design to be printed thereon, the user uses user GUI 24 to instruct design site 26 to transmit data and instructions to manufacturer 28 necessary for creation of an article with design thereon as created by the user using the method and system disclosed herein. The instructions may include the pattern pieces with designs selected by the user GUI 24 placed thereon whereby the manufacturer 28 receives the pattern pieces and creates the article designed by the user.

Multiple users may access the same article information and templates, however each user may customize or tailor each article template with a design the user uploads for printing or display on the article as described below. Users may modify the garment sizing to their personal size and measurements.

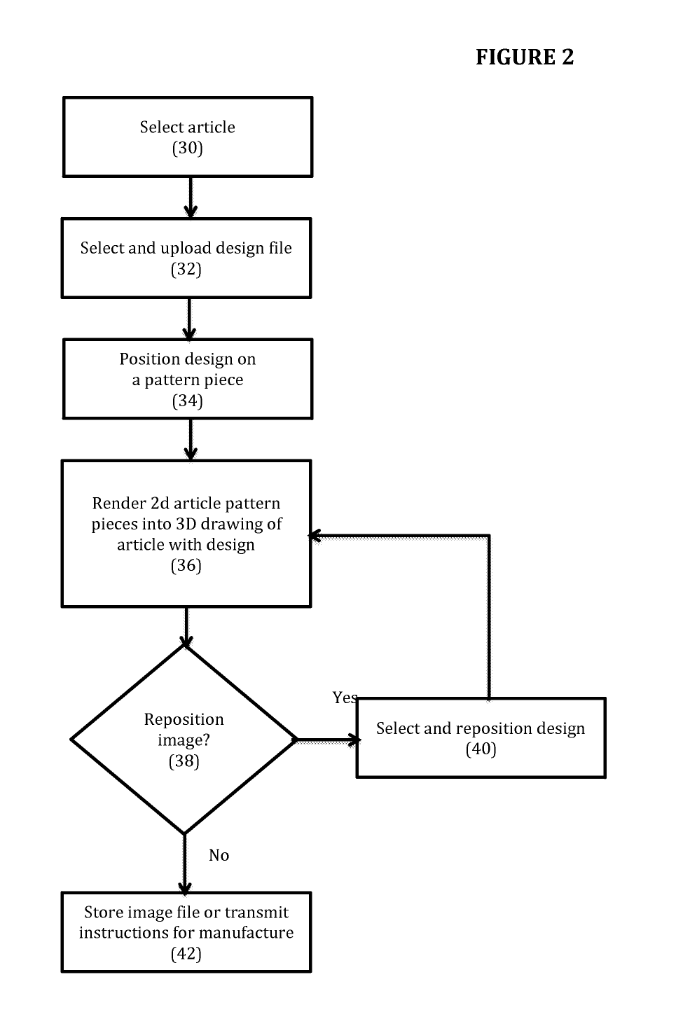

Referring to FIG. 2, the sequence of steps (30-42) will be illustrated in the context of creating a custom design on an article as described herein. The user is prompted to select an article or article pattern displayed on the user GUI (e.g. such as a shirt, pants, or dress) on which the user wishes to print or otherwise display one or more designs at one or more locations on the article (Step 30). After selecting the article, the article pattern pieces are displayed to the user in 2D on the user GUI and the user then selects a custom design for printing or display on the article which is then uploaded by the user to the design site (Step 32). The user then places and positions the design at desired locations on one or more pattern pieces (Step 34). After placement, the user instructs the design site to render the 2d pattern pieces into a 3d rendering depicting the pattern pieces in an assembled form that allows the user to view the design as it will be printed or otherwise displayed on the article (Step 36). If the user wishes to reposition the one or more designs on the article, the user repositions, enlarges, shrinks or otherwise manipulates the design on one or more pattern pieces (Step 40) as they wish and then instructs the design site to render the modified flat (2D) pattern pieces in an assembled 3D depiction of the article which allows the user to view the modified design as it will be printed or otherwise displayed on the article (Step 36). The method allows the user to continue to modify the design displayed on the article until the user is satisfied with the appearance of the article and design thereon. Once the user is satisfied with the article and design thereon, the user acknowledges the design is complete (Step 42). After completion, the user may store the article and design locally on the user GUI 24, database 22, or on design site 26 as an electronic file which may used by automated manufacturing equipment or manufacturing personnel to create the article and affix the design on the article as created by the user by means known in the art, including but not limited to, such as printing, 3D printing, stitching, sewing or by adhesives.

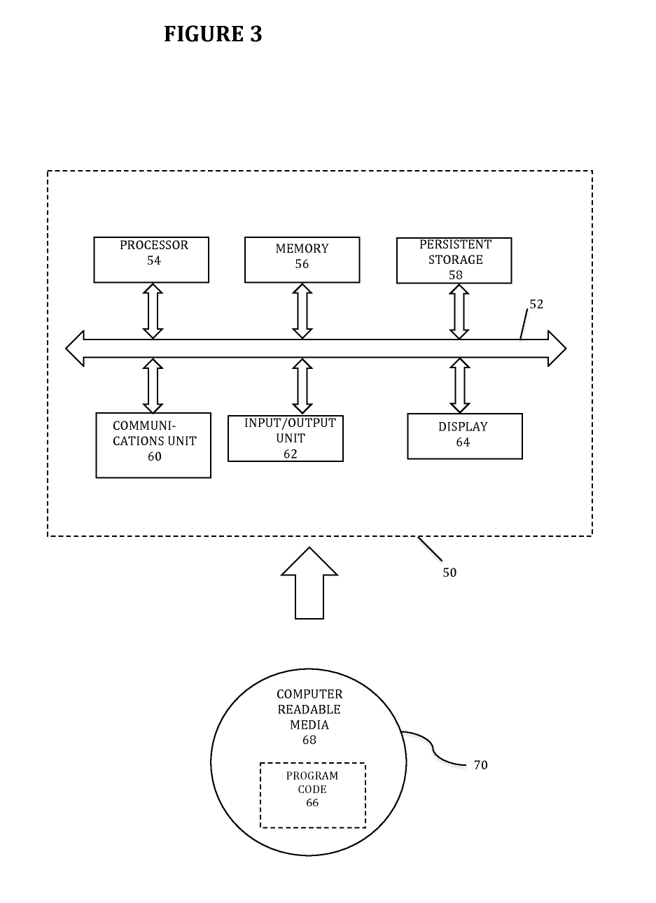

Referring now to FIG. 3, a block diagram of a computing device 50 is shown in which the illustrative embodiments may be implemented. The computing device 50 may be a computer, a user GUI, or any other suitable device or combination of devices. Computer-usable program code or instructions implementing the processes used in the illustrative embodiments may be located on the computing device 50. The computing device 50 includes a communications fabric 52, which provides communications between a processor unit 54, a memory 56, a persistent storage 58, a communications unit 60, an input/output (I/O) unit 62, and a display 64.

The processor unit 54 serves to execute instructions for software that may be loaded into the memory 56. The processor unit 54 may be a set of one or more processors or may be a multi-processor core, depending on the particular implementation. Further, the processor unit 54 may be implemented using one or more heterogeneous processor systems in which a main processor is present with secondary processors on a single chip. As another illustrative example, the processor unit 54 may be a symmetric multi-processor system containing multiple processors of the same type.

The memory 56, in these examples, may be, for example, a random access memory or any other suitable volatile or non-volatile storage device. The persistent storage 58 may take various forms depending on the particular implementation. For example, the persistent storage 58 may contain one or more components or devices. For example, the persistent storage 58 may be a hard drive, a flash memory, a rewritable optical disk, a rewritable magnetic tape, or some combination of the above. The media used by the persistent storage 58 also may be removable. For example, a removable hard drive may be used for the persistent storage 58.

The communications unit 60, in these examples, provides for communications with other data processing systems or communication devices. In these examples, the communications unit 60 may be a network interface card. The communications unit 60 may provide communications through the use of either or both physical and wireless communication links.

The input/output unit 62 allows for the input and output of data with other devices that may be connected to the computing device 50 and which may be connected to a network. For example, the input/output unit 62, may provide a connection for user input through a keyboard and mouse. Further, the input/output unit 62 may send output to a processing device. In the case in which the computing device 50 is a cellular phone, the input/output unit 62 may also allow devices to be connected to the cellular phone, such as microphones, headsets, and controllers. The display 64 provides a mechanism to display information to a user, such as a graphical user interface.

Instructions for the operating system and applications or programs are located on the persistent storage 58. These instructions may be loaded into the memory 56 for execution by the processor unit 54. The processes of the different embodiments may be performed by the processor unit 54 using computer-implemented instructions, which may be located in a memory, such as the memory 56. These instructions are referred to as program code, computer-usable program code, or computer-readable program code that may be read and executed by a processor in the processor unit 54. The program code in the different embodiments may be embodied on different physical or tangible computer-readable media, such as the memory 56 or the persistent storage 58.

Program code 66 is located in a functional form on a computer-readable media 68 and may be loaded onto or transferred to the computing device 50 for execution by the processor unit 54. The program code 66 and the computer-readable media 68 form computer program product 70 in these examples. In one embodiment, the computer program product 70 is an application or program module encompassing the method described in FIG. 2. In this embodiment, the program code 66 may include computer-usable program code capable of selecting an article pattern from a user. The program code 66 may also include computer-usable program code capable of selecting and uploading a design to be positioned on one or more article pattern pieces displayed on a user GUI. The program code 66 may also include computer-usable program code capable of directing a user to position an uploaded design on to one or more article pattern pieces depicted on a user GUI. The program code 66 may also include computer-usable program code capable of rendering one or more 2D pattern pieces into a 3D image of an article with design depicted on a user GUI. The program code 66 may also include computer-usable program code capable of allowing a user to reposition or manipulate the design on one or more pattern pieces displayed in the 3D rendering. The program code 66 may also include computer-usable program code capable of directing the user to print one or more pattern pieces of article with design printed or displayed thereon. The program code 66 may also include computer-usable program code capable of directing the user to print, 3D print the article or otherwise transmit instructions to another user, a manufacturer or to a machine equipment for producing the article with design. Any combination of the above-mentioned computer-usable program code may be implemented in the program code 66, and any functions of the illustrative embodiments may be implemented in the program code 66.

In one example, the computer-readable media 68 may be in a tangible form, such as, for example, an optical or magnetic disc that is inserted or placed into a drive or other device that is part of the persistent storage 58 for transfer onto a storage device, such as a hard drive that is part of the persistent storage 58. In a tangible form, the computer-readable media 68 also may take the form of a persistent storage, such as a hard drive or a flash memory that is connected to the computing device 50. The tangible form of the computer-readable media 68 is also referred to as computer recordable storage media.

Alternatively, the program code 66 may be transferred or deployed to the computing device 50 from the computer-readable media 68 through a communication link to the communications unit 58 or through a connection to the input/output unit 62. The communication link or the connection may be physical or wireless in the illustrative examples. The computer-readable media 68 also may take the form of non-tangible media, such as communication links or wireless transmissions containing the program code 66 transmitted via network 20 among a user GUI 24, database 22, design site 26 or manufacturer 28. In one embodiment, the program code 66 is delivered to the computing device 50 over the Internet.

The different components illustrated for the computing device 50 are not meant to provide architectural limitations to the manner in which different embodiments may be implemented. The different illustrative embodiments may be implemented in a data processing system including components in addition to or in place of those illustrated for computing device 50. Other components shown in FIG. 3 can be varied from the illustrative examples shown.

As one example, a storage device in the computing device 50 is any hardware apparatus that may store data. The memory 56, the persistent storage 58, and the computer-readable media 68 are examples of storage devices in a tangible form.

In another example, a bus system may be used to implement the communications fabric 52 and may be comprised of one or more buses, such as a system may be implemented using any suitable type of architecture that provides for a transfer of data between different components or devices attached to the bus system. Additionally, the communications unit 60 may include one or more devices used to transmit and receive data, such as modem or a network adapter. Further, a memory may be, for example, the memory 56 or a cache such as found in an interface and memory controller hub that may be present in the communications fabric 52.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

1. A method for creating a custom design on an article, comprising:
uploading a file comprising a design to a design site or a software application;
positioning the design on a flat two-dimensional image of an article comprising one or more pattern pieces;
editing the location of the design on the one or more pattern pieces;
rendering one or more pattern pieces from the flat two-dimensional image into a three-dimensional object depicting the article with the design on the article; and
displaying the article and design depicted on the article on a display.

2. The method of claim 1 further comprising:
uploading a second file comprising a design that includes a text or an art design.

3. The method of claim 1 wherein the article is one from the group consisting of clothing, headwear, footwear, furniture, upholstery, fabrics, and toys.

4. The method of claim 1 further comprising: affixing the design on the article.

5. A computer program product in a non-transitory computer readable medium, the computer program product comprising:
instructions for uploading one or more designs that include a text or an art design;
instructions for prompting a user to position the one or more uploaded designs on to one or more two-dimensional pattern pieces of an article;
instructions for rendering the two-dimensional pattern pieces of the article into a three-dimensional object and displaying the design on the article.

6. The computer program product of claim 5 further comprising instructions for sewing, stitching, gluing, stapling, buttoning or printing the one or more pattern pieces for the article with design shown in the three-dimensional rendering.

7. The computer program product of claim 5 further comprising instructions for relocating the design relative to one or more pattern pieces.

8. The computer program product of claim 5 further comprising instructions for resizing the design relative to one or more pattern pieces.

9. A method, comprising the steps of:
uploading a design created by the user;
positioning the design on one or more two-dimensional pattern pieces describing a three-dimensional article;
editing the design based on user inputs;
rendering the two-dimensional pattern pieces for the article into a three-dimensional object depicting the article with the design on the article; and,
displaying the three-dimensional article with the design depicted on the article.

10. The method of claim 9 wherein the editing step includes re-sizing the design, reorienting the design, recoloring, or adding or deleting portions of the design located on the article.

11. The method of claim 9 further comprising:
storing the article with the design depicted on the article in an electronic medium.

12. The method of claim 9 further comprising:
transmitting instructions for cutting the pattern pieces for the article with the design depicted on the article.

13. The method of claim 9 further comprising:
transmitting instructions for manufacturing the pattern pieces for the article with the design depicted on the article.

14. The method of claim 9 further comprising:
transmitting instructions for manufacturing the article with the design depicted on the article to a manufacturer.

15. The method of claim 9 further comprising:
transmitting instructions for 3D printing the article with the design depicted on the article.
